(19) United States
(12) Patent Application Publication
(10) Pub. No.: US 2024/0317029 A1
(43) Pub. Date: Sep. 26, 2024

(54) GLAZED ELEMENT FOR THE TRANSMISSION OF INFRARED LIGHT RAYS AND METHOD OF MANUFACTURING OF THIS GLAZED ELEMENT

(71) Applicant: SAINT-GOBAIN GLASS FRANCE, COURBEVOIE (FR)

(72) Inventors: Laurent SILVESTRINI, BUSSY (FR); Christophe KLEO, ATTICHY (FR)

(21) Appl. No.: 18/576,672

(22) PCT Filed: Jul. 7, 2022
(86) PCT No.: PCT/FR2022/051370

§ 371 Date: Jan. 4, 2024

(30) Foreign Application Priority Data
Jul. 7, 2021 (FR) FR2107357

(51) Int. Cl. B60J 1/02; B60J 1/00; B60R 11/00; B60R 11/04

(52) U.S. Cl. CPC B60J 1/02; B60J 1/008; B60R 11/04; B60R 2011/0026

(57) ABSTRACT

A glazed element includes a first glazing having a first main face and a second main face, and an opening, the opening defining an inner wall of the first glazing and extending along a thickness of the first glazing, and an infrared light transmission system fixedly mounted to the first glazing and inserted in the opening.

### FIELD OF THE INVENTION

The present invention relates to a glazed element, for example a windscreen or a side glass pane of a vehicle. In particular, the present invention relates to a glazed element suitable for the transmission of infrared light rays.

### STATE OF THE ART

In a vehicle, it is known to use a thermal camera, adapted to image infrared radiation. The resulting image can be used by a driver assistance system. Indeed, the thermal camera can allow a driver of the vehicle to distinguish obstacles to the driving of the vehicle in foggy conditions, or for example low light conditions. The thermal camera can be connected to a driver assistance system, so that it automatically detects obstacles that are not visible to the vehicle driver.

However, the integration of a thermal camera inside the vehicle may be prevented by the absorption of infrared light rays from a vehicle glazing. Indeed, the transmission rate of a light ray through a windscreen is typically lower than 50% at a light ray wavelength higher than 800 nanometers.

To this end, WO 2021/043838 describes a glazed element wherein a windscreen glazing comprises an opening. An insert made of a material transparent to infrared light is arranged in the opening. Thus, the infrared light rays can pass through the windscreen through the insert, so that they can be detected by a thermal camera arranged inside the vehicle. In order to seal the windscreen through the opening, a ring of flexible material is arranged between the insert and the windscreen glazing to form a seal. The ring is glued to a wall formed by the opening.

However, the flushness of the insert and the glazing is not assured by such a glazed element. Indeed, during the manufacturing of the glazed element, a precise alignment of the insert and the glazing on the same external surface is difficult to implement. In addition, an adhesive used to attach the ring to the windscreen glass may spill over onto an external face of the glass, thus damaging the flushness of the glazed element.

### OVERVIEW OF THE INVENTION

An object of the invention is to provide a solution for facilitating and improving an alignment between a vehicle glazing and an insert adapted to transmit infrared light rays in such a glazing, while improving the flushness of the glazing and the insert with respect to the state of the art.

This purpose is at least partially achieved within the scope of the present invention by means of a glazed element, comprising:
a first glazing extending along a first surface, the first glazing having a first main face and a second main face, opposite the first face with respect to the first glazing, the first glazing comprising an opening, the opening defining an inner wall of the first glazing, extending along a thickness of the first glazing and defining a passage between the first face and the second face, the first glazing having a first coefficient a₁ of light absorption for a light ray having at least one wavelength chosen between 800 nm and 15 μm,
an infrared light transmission system fixed to the first glazing,
the infrared light transmission system comprising a support and a second glazing, the second glazing having a second coefficient a₂ of light absorption for a light ray having at least one wavelength chosen between 800 nm and 15 μm, the second coefficient a₂ being strictly lower than the first coefficient a₁, the support comprising a side wall at least partially covering the inner wall and extending from the second face towards the first face, preferentially in a first direction perpendicular to the first surface, the support comprising a flange fixedly mounted to the side wall and extending over the second face, preferentially in a plane parallel to the first surface,
the second glazing extending along the first surface and being embedded in the support, and surrounded by the side wall so that the support and the second glazing are in direct contact,
the side wall being inserted into the opening so that the opening completely surrounds the side wall,
the flange being fixedly mounted on the second face so as to seal off the first face from the second face.

The present invention is advantageously completed by the following features, taken individually or in any of their technically possible combinations:
the glazed element comprises an adhesive layer, the adhesive layer being in contact with the second face and with a face of the flange arranged opposite the second face, the adhesive layer completely surrounding the side wall,
the side wall extends in the first direction, from the flange to at most one vertex of the support, a distance between the second face and the vertex of the support in the first direction being less than or equal to the thickness e of the first glazing, and preferentially strictly less than the thickness e of the first glazing,
the second glazing is overmolded by the support,
the support and the second glazing have form-fitting elements configured to block movement of the second glazing relative to the support in a direction normal to the first surface,
the support has an internal face, preferentially formed by the side wall and/or by the flange, the internal face being arranged facing the second glazing, the internal face comprising a notch forming a recess, the second glazing being mounted in the recess formed by the notch,
the second glazing has a base and a face opposite the base with respect to the second glazing, an area of the base being strictly greater than an area of the face, the second glazing preferentially having a frustoconical shape defined between the base and the face,
the support has an internal face, preferentially formed by the side wall and/or by the flange, the internal face being arranged facing the second glazing, the internal face comprising a notch forming a recess, the second glazing being mounted in the recess formed by the notch, and the base of the second glazing being mounted in the recess,
the second glazing has a coefficient a₂ of absorption of a light ray of less than 0.5 cm⁻¹, the light ray having at least one wavelength chosen between 800 nm and 15 μm,
the second glazing comprises zinc sulfide and/or zinc selenide,
the side wall and the flange form a monolithic element,
the glazed element comprises at least one element selected from an infrared camera, preferentially thermal, and a light source configured to emit infrared light rays, the element(s) being disposed opposite the second glazing on the side of the second face with respect to the first glazing,
the glazed element comprises a housing, the housing being fixedly mounted to the first glazing, at least one element selected from an infrared camera, preferentially a thermal camera, and a light source configured to emit infrared light rays, the element being mounted to the housing opposite the second glazing,
the second glazing has a shape selected from among an elongated shape and an angled shape, preferentially an “L” shape.

Another aspect of the invention is a method of manufacturing a glazed element according to one embodiment of the invention, the method comprising the steps of:
(a) arranging the second glazing in an injection mold, the second glazing being arranged between a plurality of centering elements, the centering elements being arranged in the injection mold and being configured to position the second glazing at a predetermined position in the injection mold,
(b) injection of a polymeric material into the injection mold so as to form the support, preferentially by overmolding the second glazing,
(c) inserting the infrared light transmission system formed by the second glazing and the support in step (b) into the opening in the first glazing.

Advantageously, the method comprises a step prior to step (c) of inserting the system, wherein a plate is mounted on the first face so as to cover the opening.

Another aspect of the invention is a second glazing having a coefficient a₂ of absorption of a light ray of less than 0.5 cm⁻¹, the light ray having at least one wavelength selected between 800 nm and 15 μm, the second glazing having a shape selected from an elongated shape and a bent shape, preferentially an “L” shape.

### DESCRIPTION OF THE FIGURES

Other features, purposes and advantages of the invention will emerge from the following description, which is purely illustrative and non-limiting, and which must be read in conjunction with the appended drawings in which:

FIG. 1 shows a cross-section of a glazed element according to one embodiment of the invention,

FIG. 2 shows a cross-section of a glazed element according to one embodiment of the invention,

FIG. 3 shows a cross-section of a glazed element according to one embodiment of the invention,

FIG. 4 shows a detail of a cross-section of a glazed element according to one embodiment of the invention,

FIG. 5 shows an overview of a glazed element according to one embodiment of the invention,

FIG. 6 shows an overview of a glazed element according to one embodiment of the invention,

FIG. 7 shows an infrared light ray transmission system according to one embodiment of the invention, which is revolution-shaped,

FIG. 8 shows an infrared light ray transmission system according to one embodiment of the invention, which is star-shaped,

FIG. 9 shows an infrared light ray transmission system according to one embodiment of the invention, which is elbow-shaped,

FIG. 10 shows a method of manufacturing a glazed element according to one embodiment of the invention,

FIG. 11 shows a detail of a cross-section of a glazed element according to one embodiment of the invention,

FIG. 12 shows a detail of a cross-section of a glazed element according to one embodiment of the invention, wherein the support has a flaring,

FIG. 13 shows a detail of a cross-section of a glazed element according to one embodiment of the invention, wherein form-fitting elements are formed by a series of grooves,

FIG. 14 shows a detail of a support of a glazed element according to one embodiment of the invention,

FIG. 15 shows a detail of a cross-section of a glazed element according to one embodiment of the invention,

FIG. 16 shows a shape of the second glazing added in a plane parallel to a thickness of the first glazing,

FIG. 17 shows a glazed element comprising a wiper device and an arrangement of the second glazing allowing a face of the second glazing to be wiped by the wiper device.

In all the figures, similar elements are marked with identical references.

### Definitions

“Glazing” means a structure comprising at least one sheet of organic or mineral glass, preferentially suitable for being mounted in a vehicle, such as a rail vehicle or motor vehicle.

The glazing can comprise a single glass sheet or a multilayer glazed assembly at least one sheet of which is a glass sheet.

A glazing may comprise an organic glass sheet. Preferably, the organic glass is formed by a compound comprising acrylates, preferably by polymethyl methacrylate (PMMA). It also can be formed by polycarbonate.

A glazing can comprise a glazed assembly. The glazed assembly comprises at least one glass sheet. The glass can be organic or mineral glass. The glass can be tempered. The glazed assembly is preferably a laminated glazing. “Laminated glazing” is understood to mean a glazed assembly comprising at least two glass sheets and an interlayer film formed of plastic material, preferentially viscoelastic, separating the two glass sheets. The interlayer film made of plastic material can comprise one or more layers of a visco-elastic polymer such as polyvinyl butyral (PVB) or an ethylene-vinyl acetate copolymer (EVA). The interlayer film is preferably made of standard PVB or of acoustic PVB (such as single-layer or tri-layer acoustic PVB). Acoustic PVB can comprise three layers: two outer layers of standard PVB and an inner layer of PVB with added plasticizer so as to make it less rigid than the outer layers.

### DETAILED DESCRIPTION OF THE INVENTION

### General Architecture of the Glazed Element 1

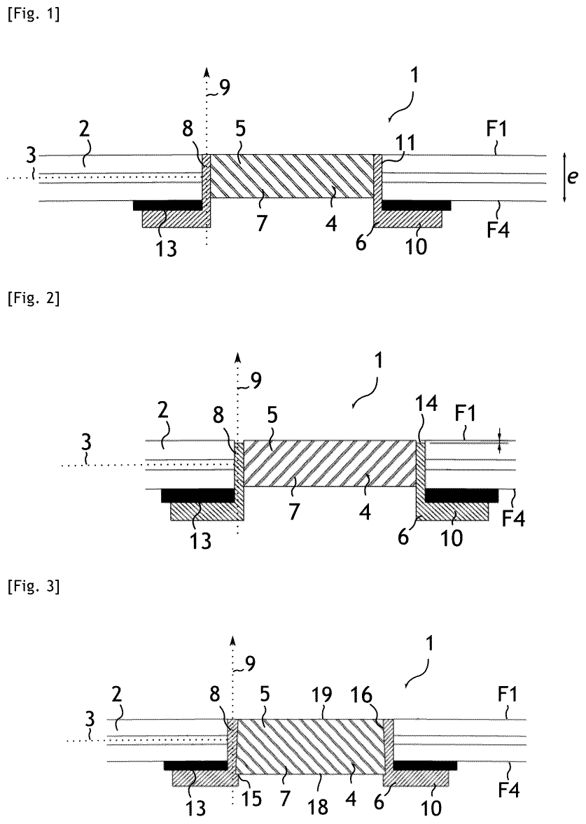

With reference to FIG. 1, FIG. 2 and FIG. 3, a glazed element 1 according to one embodiment of the invention comprises a first glazing 2 extending along a first surface 3. The first glazing 2 can be a vehicle windscreen, but also can be a vehicle side glazing, a sunroof, a vehicle rear window, for example, a heated rear window.

The first glazing 2 has a first face F1, intended to be exposed to the outside of the vehicle. The first glazing 2 has a second face F4, opposite the first face F1 with respect to the first glazing 2, and preferentially parallel to the first face F1. The second face F4 is intended to be exposed in the passenger compartment of the vehicle, that is inside the vehicle.

The first glazing 2 has a first light absorption coefficient a₁ for a light ray with at least one wavelength chosen between 800 nm and 15 μm, in the infrared radiation range. Preferentially, the first coefficient a₁ is strictly greater than 0.5 cm⁻¹, especially strictly greater than 1 cm⁻¹. Indeed, the first glazing 2 typically has a high absorption of infrared rays so as to prevent the sun's radiation from heating the vehicle's interior to temperatures that make the user uncomfortable.

The first glazing 2 comprises an opening 5. The opening 5 defines an inner wall 11 of the first glazing 2, the inner wall 11 extending along a thickness e of the first glazing 2. The opening 5 is preferentially a through-opening, connecting the first face F1 to the second face F4.

The glazed element 1 comprises a system 4 for transmitting infrared light rays. The system 4 is fixedly mounted to the first glazing 2. The infrared light transmission system 4 comprises a support 6 and a second glazing 7.

The second glazing 7 has a second light absorption coefficient a₂ for a light ray with at least one wavelength chosen between 800 nm and 15 μm. The second coefficient a₂ is strictly lower than the first coefficient a₁. Thus, the transmission of an infrared light ray is higher through the second glazing 7 than through the first glazing 2.

The support 6 comprises a side wall 8. The side wall 8 at least partially covers the inner wall 11, and preferentially completely covers the inner wall 11. The side wall 8 extends mainly from the second face F4 towards the first face F1, in particular as far as the first face F1, and preferentially along a first direction 9, perpendicular to the first surface 3.

The support 6 comprises a flange 10 fixedly mounted to the side wall 8. The flange 10 extends on the second face F4 and preferentially along a plane parallel to the first surface 3.

The second glazing 7 can extend along the first surface 3. The second glazing 7 is embedded in the support 6, while being surrounded by the side wall 8. Thus, the second glazing 7 is mechanically mounted fixedly to the support 6. The support 6 and the second glazing 7 are in direct contact. The mounting between the support 6 and the second glazing 7 can be without an adhesive layer.

The side wall 8 is inserted into the opening 5 so that the inner wall 11 surrounds the side wall 8, and preferentially completely surrounds the side wall 8.

The flange 10 is fixedly mounted on the second face F4 so as to seal the first face F1 from the second face F4. Due to the presence of the flange 10 and the mounting of the support 6 to the first glazing 2 by the flange 10, it is possible both to avoid using any adhesive between the first glazing 2 and the side wall 8, and between the side wall 8 and the second glazing 7, so as to avoid any overflow of an adhesive on the first surface F1 and thus to keep an external face of the glazed element 1 flush, while sealing off the first face F1 from the second face F4 with respect to water or dust.

### Fixed Mounting of the Flange 10 on the Second Face F4

The glazed element 1 may comprise an adhesive layer 13. The adhesive layer 13 is in contact with the second face F4 and with a face of the flange arranged opposite the second face F4. The adhesive layer 13 is arranged between the second face F4 and between the face of the flange 10 that is opposite the second face F4. The adhesive layer 13 can completely surround the side wall 8, so as to form a tight seal between the second face F4 and the flange 10.

The adhesive layer 13 can be formed by an adhesive. The adhesive can be a polyurethane (PU) adhesive. Preferentially, the adhesive forming the adhesive layer 13 has a Shore A hardness. The adhesive layer 13 can also be formed by a double-sided adhesive tape. Thus, the connection between the first face F1 and the flange 10 can be a removable connection, allowing the system 4 to be replaced during the use of the glazed element 1, for example when the second glazing 7 is damaged.

### Support 6

The support 6 comprises the side wall 8 and the flange 10. The side wall 8 extends in the first direction 9 from the flange 10 to, at the furthest, one vertex 14 of the support 6. A distance between the second face F4 and the vertex 14 of the support 6 in the first direction 9 is less than or equal to the thickness e of the first glazing 2. With reference to FIG. 2, the distance between the second face F4 and the vertex 14 of the support 6 in the first direction is strictly less than the thickness e of the first glazing 2. Thus, it is possible to control the flushness of the glazed assembly 1 so that it is impossible for the support 6 to protrude from the first face F1. Preferably, the distance between the first face F1 and the vertex 14 of the support 6 along the first direction is between 0 mm and 0.05 mm exclusive. The second glazing 7 may have a base 18 and a face 19 opposite the base with respect to the second glazing 7, preferentially locally parallel to the base 18. Preferably, the face 19 opposite the base is arranged, with respect to the first direction 9, between the second face F4 included and between the first face F1.

The side wall 8 and the flange 10 can form a monolithic element, preferentially formed by injecting a material of the support 6 into a mold.

The support 6 can be made of a thermoplastic material or a metallic material. The material of the support 6 can be, for example, polyurethane or aluminum. Preferably, the support material 6 has a coefficient of thermal expansion between 0.8 times the coefficient of thermal expansion of glass and between 1.2 times the coefficient of thermal expansion of glass. Thus, it is possible to avoid using a piece of elastic material between the first glazing 2 and the support 6, and/or between the support 6 and the second glazing 7 to compensate for the differences in thermal expansion of the different elements of the glazed element 1. The material of the support 6 preferentially comprises glass fibers. Thus, it is possible to minimize the difference between the coefficient of thermal expansion of the material of the support 6 and the coefficient of thermal expansion of the material of the first glazing 2 and/or the second glazing 7. The material of the support 6 may also comprise glass beads. The glass beads also make it possible to minimize the difference between the coefficient of thermal expansion of the material of the support 6 and between the coefficient of thermal expansion of the material of the first glazing and/or second glazing 7.

### Second Glazing 7

The second glazing 7 may have a light absorption coefficient a₂ of less than 0.5 cm⁻¹ for a light ray having at least one wavelength selected between 800 nm and 15 μm, and preferentially less than 0.1 cm⁻¹. The wavelength can be chosen between 8 μm and 12 μm and preferentially between 9.5 μm and 10.5 μm. Thus, the second glazing 7 specifically allows the transmission of light rays from a thermal camera. The second glazing 7 may be formed by a material comprising zinc sulfide (ZnS), zinc selenide (ZnSe) and/or barium fluoride. Thus, it is possible to maximize the transmission of infrared light rays through the second glazing 7 so as to thermally image elements outside the vehicle.

Preferably, the second glazing 7 is an insert. The insert may be formed by a monolithic material having a light absorption coefficient a₂ of less than 0.5 cm⁻¹ for a light ray having at least one wavelength selected between 800 nm and 15 μm, and preferentially less than 0.1 cm⁻¹.

The material of the second glazing 7 may comprise:
a compound comprising a multispectral zinc sulfide, particularly obtained after hot isostatic pressing, particularly comprising selenium, such as ZnSₓSe₁₋ₓ where x is greater than or equal to 0.97 inclusive, and less than 1 inclusive, in particular the multispectral ZnS, and/or
or a compound comprising a zinc selenide, in particular ZnSe, particularly including sulfur, such as ZnSe_{y}S_{1-y}, where y is preferably greater than or equal to 0.97 inclusive and less than 1 inclusive, and/or
a compound comprising a barium fluoride, particularly comprising calcium and/or strontium, particularly Ba₁₋ᵢ₋ⱼCaᵢSrⱼF₂ where i+j are strictly less than 1, and i and j are preferably each greater than 0.25 inclusive, or Ba₁₋ᵢCaᵢF₂ where i is strictly less than 1 and preferably greater than 0.25 inclusive, in particular BaF₂.

The second glazing 7 can be transparent to a light ray with a wavelength between 800 nm and 15 μm, i.e. in the infrared light spectrum. In particular, the second glazing 7 can have a light transmission of at least 50%, and in particular of at least 70%, for a light ray with a wavelength between 800 nm and 15 μm.

The second glazing 7 can be transparent to a light ray with a wavelength between 400 nm and 800 μm, i.e. in the visible spectrum. In particular, the second glazing 7 can have a light transmission of at least 50%, and in particular of at least 70%, for a light ray with a wavelength between 400 nm and 800 μm.

Preferably, the second glazing 7 is made of a material with a modulus of rupture greater than 20 MPa. The material forming the second glazing 7 can be polycrystalline, and can be obtained by chemical vapor deposition and/or by hot isostatic pressing.

Alternatively, the material forming the second glazing 7 may be an organic material and comprise a cross-linked hybrid organo-sulfur polymer, comprising linear sulfur chains cross-linked by organic comonomers. Preferably, the organic comonomers can be selected from the group consisting of 1,3-diisopropenylbenzene (DIB), 1,3,5-triisopropenylbenzene (TIB), di-iodobenzene, norbornadiene (NBD), dimeric norbornadiene (NBD2), and tetravinyltin (TVSn). The hybrid organo-sulfur polymer may have 0.5 to 5% by mass of another element belonging to the group of chalcogens, which preferably is selenium (Se). A glass transition temperature of the organic material can be above 50° C. inclusive, and preferably in a range of 60° C. to 180° C. inclusive, and preferentially 80° C. to 160° C. inclusive.

The second glazing 7 preferably has a shape selected from among an elongated shape and an angled shape, preferentially an “L” shape, the shape of the second glazing being preferentially related to the first surface 3. Thus, it is possible to arrange several optical elements opposite the second glazing 7 while minimizing its size.

### Infrared Light Transmission System 4

With reference to FIG. 1, FIG. 2, and FIG. 3, the second glazing 7 can be embedded in the support by overmolding the second glazing 7 by the support 6. The second glazing 7 is thus overmolded by the support 6. Thus, it is possible to avoid using an adhesive to mount the second glazing 7 to the support 6.

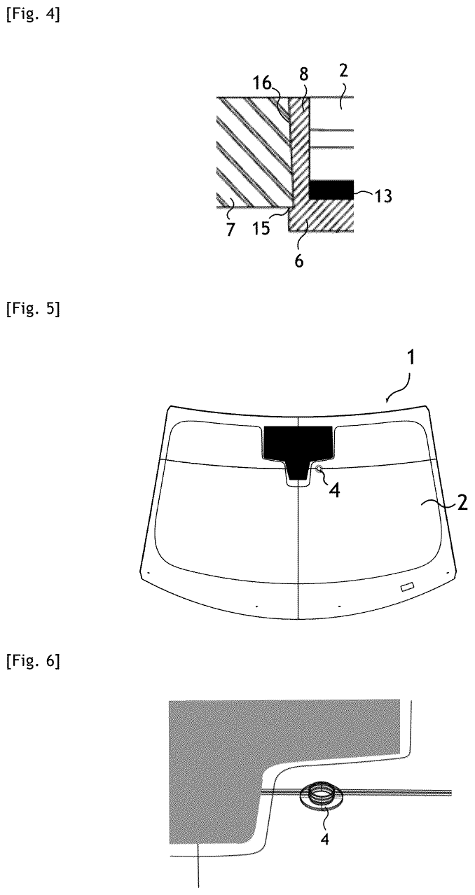

With reference to FIG. 3 and FIG. 4, the support 6 and the second glazing 7 may have form-fitting elements configured to block movement of the second glazing 6 relative to the support in a direction normal to the first surface 3. The form-fitting elements can be a pair of elements formed by a notch and a boss. The notch may be formed in the support 6 and the boss may be formed on the second glazing 7, or the notch may be formed in the second glazing 7 and the boss may be formed on the support 6. The support 6 may have an internal face 16. The internal face 16 can be formed by the side wall 8 and/or the flange 10. The internal face 16 of the support 6 is arranged opposite the second glazing 7, and may comprise a notch 15 forming a recess. The second glazing 7 can be mounted in the recess formed by the notch 15. Thus, it is possible to prevent the movement of the second glazing 7 in a direction that follows the first direction 9, without using an adhesive between the second glazing 7 and the support 6. Preferably, the notch 15 is arranged on the side of the second face F4 with respect to the first glazing 2.

With reference to FIG. 3 and FIG. 4, the second glazing 7 may have a base 18 and a face 19 opposite the base with respect to the second glazing 7, preferentially locally parallel to the base 18, an area of the base 18 being strictly greater than an area of the face 19. Thus, due to an asymmetry of the second glazing 7 with respect to the first surface 3, the movement of the second glazing 7 is not allowed in a direction normal to the first surface 3. Preferentially, the second glazing 7 has a frustoconical shape defined between a base of the second glazing 7 and a face of the second glazing 7 parallel to the base of the second glazing 7. Thus, due to the contact between the side wall 8 and a frustoconical wall of the second glazing 7, it is possible to prevent a movement of the second glazing 7 in a direction that follows the first direction 9, oriented from the base of the second glazing 7 towards the face of the second glazing 7 parallel to the base. With reference to FIG. 16, the second glazing 7 can have a shape which, when added in a plane parallel to the first direction 9, does not have an angle strictly less than 90°. Thus, the edges of the glazing 7 are mechanically reinforced. In particular, the shape may comprise a cylindrical end, i.e., one whose generatrices are parallel, so that the shape added in a plane parallel to the first direction 9 has a base forming angles α equal to 90°. The remainder of the shape, i.e., the portion extending from the cylindrical end to the face 19, may be frustoconical. The thickness d₄ of the cylindrical end with respect to the first direction 9 may be greater than 0.2 mm, in particular 0.6 mm, and preferentially 1 mm.

Preferably, the base of the second glazing 7 is mounted in the recess. Thus, it is possible to prevent movement of the second glazing 7 in the first direction 9 without using an adhesive between the second glazing 7 and the support 6.

With reference to FIG. 5 and to FIG. 6, the system 4 is preferentially arranged on the periphery of the first glazing 2. The system 4 can be arranged near the location of the first glazing 2 on which a vehicle rear-view mirror is mounted.

### Driving Assistance System

The glazed element 1 may comprise at least one infrared camera, preferentially thermal. The camera is placed opposite the second glazing 7 on the side of the second face F4 with respect to the first glazing 2. The glazed element 1 can also include a LIDAR (Laser Imaging Detection And Ranging). The LIDAR may comprise an infrared camera and a light source configured to emit an infrared light ray, detectable by the infrared camera. The infrared camera is then arranged opposite the second glazing 7 on the side of the second face F4 with respect to the first glazing 2, and the light source is also arranged opposite the second glazing 7 on the side of the second face F4 with respect to the first glazing 2. Thus, it is possible to use the same system 4 for the transmission of infrared light rays coming from and/or going to several optical elements arranged opposite the second glazing 7, which makes it possible to simplify the manufacture of a driving assistance system.

The glazed element 1 may comprise a housing. The housing can be fixed to the first glazing 2. At least one infrared camera, preferentially thermal, can be mounted on the housing opposite the second glazing 7. A LIDAR can also be mounted to the housing. The glazed element 1 may comprise a part comprising the support 6 and the housing, the support 6 being fixedly mounted to the housing. Thus, the housing can be fixed to the first glazing 2 by means of the flange 10 of the support 6. The part can be monolithic and form both the support 6 and the housing.

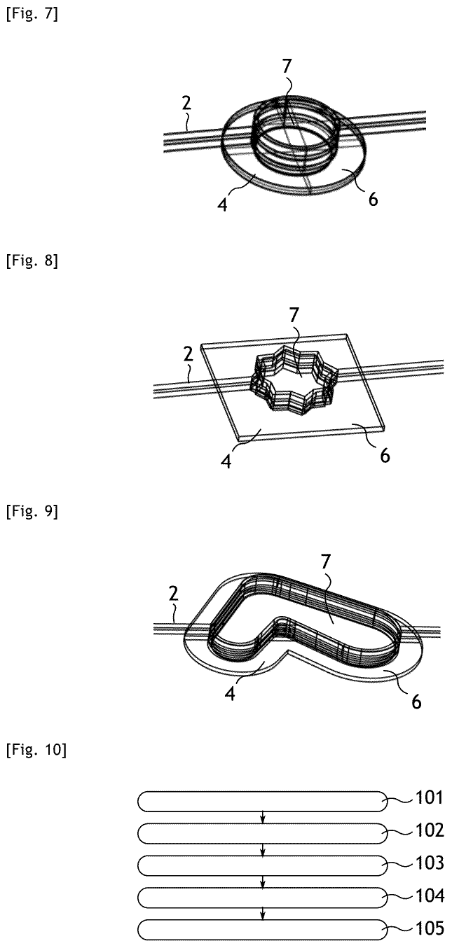

With reference to FIG. 7, FIG. 8 and FIG. 9, the shape of the support 6 and the shape of the second glazing 7 can be chosen so as to allow the arrangement of different infrared light emitting or receiving elements opposite the second glazing 7. In particular, with reference to FIG. 9, the system 4 and/or the second glazing 7 may have an elongated or angled or “L” shape for these purposes.

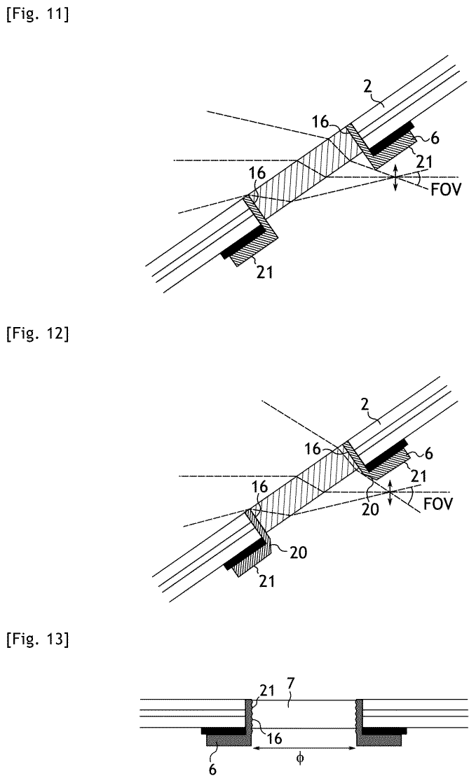

The flange 10 comprises an external face 21, opposite the face of the flange arranged opposite the second face F4 with respect to the flange. With reference to FIG. 12, the support 6 may have a flare 20 forming a wall between the internal face 16 and the external face 21. FIG. 11 shows a glazing 2 without a flare 20 and FIG. 12 shows a glazing 2 comprising a flare 20. Here the term “flare” means that an area of a surface defined by the internal face 16 relative to the first surface 3 is strictly less than an area of a surface defined by the flare 20 relative to the first surface 3. Thus, light rays passing through the second glazing 7 in the vicinity of the internal face 16 can be imaged by a camera arranged inside a passenger compartment without encountering an edge formed between the internal face 16 and the external face 21. This allows the camera to image an object with a higher FOV than without a flare 20, thus avoiding vignetting when imaging the object.

The flare 20 may also exhibit rotational asymmetry about the first direction 9. Thus, it is not necessary to orient the support 6 during the manufacture of the glazed element 1, especially when it is mounted fixedly to the first glazing 2.

The flare 20 may be a bevel implemented on an edge formed by the internal face 16 of the side wall and/or by the external face 21. The flare 20 may be a chamfer formed between the internal face 16 and the external face 21.

With reference to FIG. 13, the form-fitting elements can be formed by a series of grooves 22 formed on the internal face 16 and by a series of grooves 22 formed on the second glazing 7, the grooves formed on the internal face 16 having a form-fit with the grooves 22 formed on the second glazing 7. Each groove 22 may form a closed line along the internal face 16.

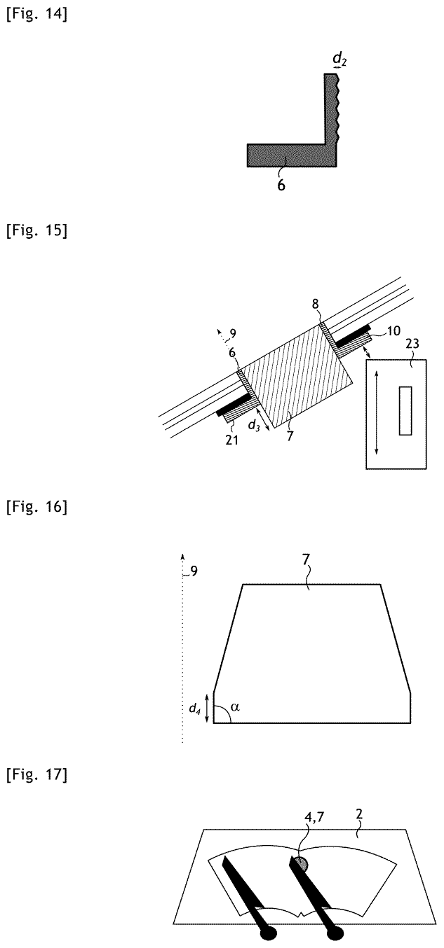

These grooves 22 can be parallel to one another. Preferably, the form-fitting elements comprise at least two grooves 22, preferably at least three grooves 22, more preferably at least four grooves 22. Thus, at least a part of the internal face 16 avoids a parasitic reflection of light rays. With reference to FIG. 14, a section of the grooves 22 in a plane perpendicular to the first surface 3 forms sawteeth. Thus, it is possible to avoid a reflection of light rays on the internal face 16 within a predetermined range of angles.

The second glazing 7 of the glazed element 1 has an apparent diameter φ. The apparent diameter φ is determined by the geometry of the second glazing 7. The apparent diameter φ0 can also be determined by the geometry of the form-fitting elements. With reference to FIG. 14, the form-fitting elements may have a thickness d₂ along an axis defined by a diameter of the second glazing 7. This thickness d₂ can be less than one-tenth of the diameter of the second glazing 7, and preferentially less than one twentieth of the diameter of the second glazing 7. The thickness d₂ may be less than 1 mm. Thus, it is possible to mechanically hold the second glazing 7 in the support 6 in the absence of an adhesive while maximizing the apparent diameter φ of the second glazing 7.

With reference to FIG. 15, the second glazing 7 may extend in the first direction 9 from the side wall 8 toward the flange 10, protruding beyond the external face 21 of the flange 10 by a protrusion distance d₃. A part of the second glazing 7 is then arranged on a side opposite the side wall 8 with respect to the flange 10. Thus, it is possible to reduce and/or eliminate the vignetting effect when imaging the object, by widening the field of view with respect to a glazed element wherein the second glazing 7 would not extend beyond the external face 21 of the flange 10. Furthermore, with reference to FIG. 15, the protrusion of the second glazing 7 from the external face 21 avoids steric problems when arranging the camera 23 opposite the second glazing 7.

### Manufacture of Glazed Element 1 and System 4

Referring to FIG. 10, another aspect of the invention is a method of manufacturing a glazed element 1.

The method comprises a step of arranging 101 the second glazing 7 in an injection mold, the second glazing 7 being arranged between a plurality of centering elements, the centering elements being arranged in the injection mold and being configured to position the second glazing 7 at a predetermined position in the injection mold. This allows the second glazing 7 to be precisely centered in the support 6. Preferably, the second glazing 7 is also fixedly mounted between two spindles that hold the second glazing 7 at a predetermined height in the injection mold.

The method comprises a step of injecting 102 a polymeric material into the injection mold so as to form the support 6, preferentially by overmolding the second glazing 2.

Preferably, the method comprises a step 103 wherein a plate is mounted on the first face F1 so as to cover the opening. Thus, when the support 6 is subsequently inserted into the opening 5, the vertex of the support 6 and the first face F1 of the first glazing 2 are flush. Indeed, it is not possible, thanks to the plate, for the vertex of the support 6 to protrude beyond the first face F1. Preferably, the plate comprises one seal, preferentially two seals. The seal or seals are each arranged in contact with the first glazing 2 and in contact with the second glazing 7 so as to block any passage between the second face F4 and the first face F1. The overmolding implemented on its joints makes it possible to form a depression formed by the support 6 arranged between the first glazing 2 and the second glazing 7.

The method comprises a step of inserting 104 the system 4 formed by the second glazing 7 and the support 6 during step 102 into the opening 5 of the first glazing 2.

### Windscreen Wiper Device 24

With reference to FIG. 17, the glazed element 1 can comprise a windscreen wiper device 24. The windscreen wiper device 24 comprises at least one wiper blade 25 arranged in contact with the first face F1 of the first window. The windscreen wiper device 24 is configured to control a movement of the wiper blade 25 such that contact between the wiper blade 25 and the first face F1 defines a wipeable surface 26 in the first face F1. The second glazing 7 may have a base 18 and a face 19 opposite the base with respect to the second glazing 7, preferentially locally parallel to the base 18. The second glazing 7 can be arranged so that the face 19 is comprised in the wipeable surface 26. Thus, it is possible to clean both the first glazing 2 and the second glazing 7 when using the windscreen wiper device 24.

1. A glazed element, comprising:
a first glazing extending along a first surface, the first glazing having a first main face and a second main face, opposite the first face with respect to the first glazing, the first glazing comprising an opening, the opening defining an inner wall of the first glazing, extending along a thickness of the first glazing and defining a passage between the first face and the second face, the first glazing having a first coefficient a₁ of light absorption for a light ray having at least one wavelength chosen between 800 nm and 15 μm,
an infrared light transmission system mounted fixedly to the first glazing, wherein:
the infrared light transmission system comprises a support and a second glazing, the second glazing having a second coefficient a₂ of light absorption for a light ray having at least one wavelength chosen between 800 nm and 15 μm, the second coefficient a₂ being strictly lower than the first coefficient a₁,
the support comprising a side wall at least partially covering the inner wall and extending from the second face towards the first face, the support comprising a flange mounted fixedly to the side wall and extending over the second face,
the second glazing extending along the first surface and being embedded in the support, and surrounded by the side wall so that the support and the second glazing are in direct contact,
the side wall being inserted into the opening so that the opening completely surrounds the side wall, and
the flange being fixedly mounted on the second face so as to seal off the first face from the second face.

2. A glazed element according to claim 1, comprising an adhesive layer, the adhesive layer being in contact with the second face and with a face of the flange arranged opposite the second face, the adhesive layer completely surrounding the side wall.

3. The glazed element according to claim 1, wherein the side wall extends in the first direction from the flange to, at the furthest, one vertex of the support, a distance between the second face and the vertex of the support in the first direction being strictly less than the thickness e of the first glazing.

4. The glazed element according to claim 1, wherein the second glazing is overmolded by the support.

5. The glazed element according to claim 1, wherein the support and the second glazing have form-fitting elements configured to block movement of the second glazing relative to the support in a direction normal to the first surface.

6. The glazed element according to claim 1, wherein the support has an internal face, the internal face being arranged opposite the second glazing, the internal face comprising a notch forming a recess, the second glazing being mounted in the recess formed by the notch.

7. The glazed element according to claim 1, wherein the second glazing has a base and a face opposite the base with respect to the second glazing, an area of the base being strictly greater than an area of the face.

8. The glazed element according to claim 7, wherein the support has an internal face, the internal face being arranged opposite the second glazing, the internal face comprising a notch forming a recess, the second glazing being mounted in the recess formed by the notch, and wherein the base of the second glazing is mounted in the recess.

9. The glazed element according to claim 1, wherein the second glazing has a coefficient a₂ of absorption of a light ray of less than 0.5 cm⁻¹, the light ray having at least one wavelength selected between 800 nm and 15 μm.

10. The glazed element according to claim 1, wherein the side wall and the flange form a monolithic element.

11. The glazed element according to claim 1, comprising at least one infrared camera, the infrared camera being arranged opposite the second glazing on the side of the second face with respect to the first glazing.

12. The glazed element according to claim 11, comprising a housing, the housing being fixedly mounted to the first glazing, and at least one infrared camera, the infrared camera being mounted to the housing facing the second glazing.

13. The glazed element according to claim 1, wherein the second glazing has a shape, added to the first surface, selected from an elongated shape and an elbow shape.

14. A method for manufacturing a glazed element according to claim 1, the method comprising the steps of:
(a) arranging the second glazing in an injection mold, the second glazing being arranged between a plurality of centering elements, the centering elements being arranged in the injection mold and being configured to position the second glazing at a predetermined position in the injection mold,
(b) injection of a polymeric material into the injection mold so as to form the support, by overmolding the second glazing, and
(c) inserting the infrared light transmission system formed by the second glazing and the support in step (b) into the opening in the first glazing.

15. The method for manufacturing a glazed element according to claim 14, comprising a step prior to step (c) of inserting the system, during which a plate is mounted on the first face so as to cover the opening.

16. The glazed element according to claim 7, wherein the second glazing has a frustoconical shape defined between the base and the face.

17. The glazed element according to claim 9, wherein the second glazing comprises a member selected from zinc sulfide, zinc selenide and a cross-linked hybrid organo-sulfur polymer, comprising linear sulfur chains cross-linked by organic comonomers.

18. The glazed element according to claim 11, wherein the at least one infrared camera is a thermal infrared camera.

19. The glazed element according to claim 12, wherein the least one infrared camera is a thermal infrared camera.

20. The glazed element according to claim 13, wherein the second glazing an L shape.
